(19) United States
(12) Patent Application Publication
(10) Pub. No.: US 2006/0077975 A1
(43) Pub. Date: Apr. 13, 2006

(54) Checking method for applying in the field of network packet contents of network security switch

(75) Inventors: Nen-Fu Huang, Hsin-Chu City (TW); Chih-Hao Chen, Pan-Chiao City (TW)

Correspondence Address: BIRCH STEWART KOLASCH & BIRCH, PO BOX 747, FALLS CHURCH, VA, 22040-0747, US

(73) Assignee: BROAD WEB CORPORATION, Hsin-City (TW)

(21) Appl. No.: 11/006,583

(22) Filed: Dec. 8, 2004

(30) Foreign Application Priority Data
Oct. 8, 2004 (TW) 093130559

(51) Int. Cl. H04L 12/56; H04L 12/28

(52) U.S. Cl. 370/389

(57) ABSTRACT

A checking method for applying in the field of network packet contents of network security switch, specially, it focus on a specific designed IDP (intrusion detection/prevention) can cooperate with any L2 switch that matched some popular specifications and provide security service on the network traffic through the L2 switch. The applicant abstract the security concept from the security switch. Thus, under this architecture, we developing and improving the network security domain can focus on the security technology without take care what the L2 switch have already been well done. and the additional benefit of the proposed architecture is the cost will relatively lower than the current, and the enterprises using this solution do not need to replace the L2 switch with security switch, we can only plug the spcific designed IDP to the L2 switch we have already had, and play what we original want with security service.

### FIELD OF THE INVENTION

The present invention is related to a checking method for applying in the field of network packet contents of network security switch. The specialty is under the structure of network security mechanism of security switch, thus, we can have more convenient, more cheaper and more faster of checking method of detection and prevention of intrusion packets; so, the applicant base on this concept, then proposed a idea of IDP service provider to check and prevent the intrusion packets, further, we cooperate the L2 switch to be a network security mechanism, the special designed IDP system it can take control of the L2 switch connected to it, the IDP service provider fetches the filtering database of the L2 switch and controls the network traffic flow in and out of the L2 switch, thus, every packet the L2 switch received will be redirected to the IDP service provider and checked by it. The IDP service provider will then tag the forwarding information on the packet by mean of VLAN tag format and return the packet back to the L2 switch. The additional benefit of the proposed architecture is the cost will relatively lower than the current, and the enterprises using this solution do not need to replace the L2 switch with security switch, we can only plug the specific designed IDP to the L2 switch we have already had, and play what we original want with security service.

### BACKGROUND OF THE INVENTION

Due to the developing of network technology, the opportunities of people using network are more often, so, the information exchange flow is bigger and bigger day by day, but for this reason, the network intrusion is very serious more and more, just like attacking government workstation, every kind of server, even personal computer. Recent years, the network intrusion detection system is a very important technology, the key point of this key technology is to cut down the cost and checking out the attack packets by integrating the original network equipments, this is the key point to prevent the network security, therefore, how we to propose a checking method can integrate network equipments in NIDS, by the way can increase the checking number of packet and let the cost down are very important in network technology.

The prior arts just like fire wall, intrusion detection system, intrusion prevention system, server, even virtue private network (VPN) etc, it used to achieve the protection purpose of network. But nowadays, the network technology is to consider how to achieve the purposes of intrusion detection/prevention under the original equipments, and to get the basic protection by security switch which is the original structure in network.

What we describe above of network security mechanism are already quite detail, but if we consider about the cost, convenience and efficiency, it for middle or small enterprises are not enough, thus, the applicant proposed this idea of IDP service provider to solve the problems of prior arts.

### SUMMARY OF THE INVENTION

The present invention is related to A checking method for applying in the field of network packet contents of network security switch, comprising steps of: a) among several network stations in network terminations, by means of a media access control(MAC) of the address of source/destination of a unicast packet to decide between any two source/destination address among said several network stations; b) from a source address station, by means of a access link to link said source address station to a port of a switch, and a destination station also link to another port of said switch by said access link; c) linking a specific port of said switch to a service provider; and or d) setting a intermediate device between said source/destination stations and said switch, and linking said source/destination stations to said intermediate device by a access link, and linking said switch to said intermediate device by a trunk link.

Base on the idea described above wherein said switch is a L2 switch (layer 2 switch) a L3 switch or a L4 switch etc.

Base on the idea described above wherein said L2 switch is a exchange node in network security mechanism, it not only can set individual different VLAN to avoid interference between different work areas and different members, but it also can get the efficiency of filtration by specific link port linking by specific person through MAC address limitation.

Base on the idea described above wherein said IDP service provider is a Intrusion Detection/Prevention system service provider, it can be configured in two modes, static mode and dynamic mode, in static mode, each of the L2 switch ports is defined static in pairs, the network traffic received from one port will be statically transmitted to another after checked by said IDP service provider, it means where the packets coming will decide where the packets going, and then, in the dynamic mode, all the packets will be switched as usual but checked and considered by said IDP service provider, wherein said IDP service provider fetches the filtering database from said L2 switch and uses this information to judge where the packets must go, said L2 switch will not do the real switching, it only learns the forwarding information instinctively and passes the information when said IDP service provider querying.

Base on the idea described above wherein said IDP service provider is a specific designed can cooperate with any said L2 switch that matched some popular specifications and provide security service on the network traffic through said L2 switch, it do not need to replace said L2 switch, it just plug said specific designed IDP to said L2 switch they have already had, and play what they original want with security service.

Base on the idea described above wherein said service provider i.e. a IDP service provider, said IDP service provider can handle both IDS (intrusion detection system) and IPS (intrusion prevention system) two systems do at the same time according to the user configuration and the network environment.

Base on the idea described above wherein said VLAN we can definite VLAN-aware and VLAN-unaware, and VLAN-aware means devices are devices that are able to understand VLAN membership and VLAN frame formats.

Base on the idea described above wherein said VLAN we can definite VLAN-aware and VLAN-unaware, and VLAN-unaware means devices are devices that are not able to understand VLAN membership and VLAN frame formats.

Base on the idea described above wherein said trunk link is a LAN segment used for multiplexing VLANs between VLAN bridges, all the devices that connect to said trunk link must be VLAN-aware.

Base on the idea described above wherein said access link is a LAN segment used to multiplex one or more VLAN-unaware devices into a port of a VLAN bridge.

Base on the idea described above wherein said intermediate device are devices that are linking to L2 switch by trunk link, and are linking to source/destination stations by access link, wherein said source/destination stations are all VLAN-unaware and all are untagged packets, said intermediate device send the packets to L2 switch after tagged, then send said tagged packets to IDP service provider through a specific linking port, and send it back to L2 switch after check by IDP service provider.

### DETAILED DESCRIPTION OF PREFERRED EMBODIMENT

### Embodiment One

Please refer to FIG. 1 and FIG. 2 at the same time, wherein the FIG. 1 illustrates the graph we used to represent the IDP service provider (21), and the FIG. 2 shows if the security switch is configured in static multiple IDP and the L2 switch (22) port 1 and port 2 are connected to access link (23).

As shown in FIG. 2, both station A (24) and station B (25) are VLAN-unaware and only transmit or receive packets without VLAN tags.(26). Now, we describe the steps detail shown in FIG. 2

Step 1:

The source station A (24) sends a unicast packet to the destination station B (25). The source MAC address of this unicast packet is source station A (24) and the destination MAC address is destination station B (25).

Step 2

The L2 switch (22) receives the unicast packets which is untagged and tags (26) the PVID of port 1 internally on the packet.

The L2 switch (22) will dynamically learn the MAC address of source station A (24) from port 1 belongs to the PVID of port 1.

Since all ports were set to only one individual PVID except the IDP service port, the L2 switch (22) will not directly send the unicast packet to port 2 which is actually connected by the destination station B (25). The L2 switch (22) treats the two ports as in different VLANs when receiving untagged packets.

The L2 switch (22) will find that only port 3 (the IDP service port) belongs to the same VLAN of port 1 PVID because the IDP service port belongs to all VLAN then the L2 switch (22) forwards the unicast packet to port 3 even the MAC address of destination station B(25) has not been learned from port 3, and the IDP service provider (21) will receive the unicast packet tagged (26) with the PVID of port 1 because the egress rule of IDP service port is tagged (26).

Step 3:

The IDP service provider (21) first checks the unicast packet and will filter it if any intrusion are detected from this unicast packet.

After the packet is checked and safe, the IDP service provider (21) then lookups the source MAC address table (we will discuss how this table is updated and maintained later) and find that the packets came from port 1 shall be tagged (26) with the PVID of port 2 The source MAC address table is shown in FIG. 3.

Step 4:

The IDP service provider (21) will notice the tag (26) on the packet is the PVID of port 1, and detect the packet was untagged before the L2 switch (22) received.

So, the IDP service provider (21) modifies the tag (26) of the unicast packet which was tagged (26) by the L2 switch (22) previously to the PVID of port 2 and sends this packet to L2 switch (22) again.

Step 5:

The L2 switch (22) then receives the unicast packet again but this time the unicast packet has been tagged (26) with the PVID of port 2. The L2 switch (22) then dynamically learn that the MAC address of source station A(24) from port 3 belongs to the PVID of port 2. The L2 switch (22) will find that only port 2 can be forward because only two ports belong to the PVID of port 2: port 2 and port 3 (the IDP service port), and the packet is received from port 3; thus the unicast packet will be forward to port 2 even if MAC address of destination station B (25) has not been learned from port 2 before. The L2 switch (22) strips the VLAN tag (26) of the packet because the egress rule of port 2 is untagged and sends the untagged packet to the destination station B (25)

Finally, the destination station B (25) receives the unicast packet send from the source station A (24).

Note: Next time, if the destination station B (25) replies the source station A (24) by sending any packets the destination MAC address is source station A (24), the L2 switch (22) will judge these packets belong to PVID of port 2 and directly forward these packets to port 3 because of the L2 switch (22) has learnt the MAC address of the source station A (24) from port 3 belongs to the PVID of port 2.

### Embodiment Two

Please refer to FIG. 1 and FIG. 4 at the same time, wherein the FIG. 1 illustrates the graph we used to represent the IDP service provider (41), and the FIG. 4 shows if the security switch is configured in static multiple IDP and the L2 switch (42) port 1 and port 2 are connected to trunk link (43), thus all packets flow in and out of the two L2 switch (42) ports are tagged (48).

As shown in FIG. 4, each of port 1 and port 2 of the L2 switch (42) is connected to an intermediate device (44, may be switch or hub but VLAN-aware) separately.

These intermediate devices (44) are connected to the L2 switch (42) in trunk links but connected to the source station A (46) or the destination station B (47) in access link.

Both of the source station A (46) and the destination station B (47) are VLAN-unaware, they transmit and receive only untagged packets, but the intermediate devices (44) tag (48) the same VLAN ID on the packets received from the source station A (46) or B and send the tagged (48) packets to the L2 switch (42). The IDP service provider (41) is also connected to the L2 switch (42).

In this network topology, the source station A (46) and B are assigned in the same VLAN which different from the PVID of the L2 switch (42) ports.

In the following, we describe the steps detail shown in FIG. 4

Step 1:

First, the source station A (46) sends a unicast packet to the destination station B (47). The source MAC address of the packet is source station A (46) and the destination MAC address is destination station B.

Step 2:

The intermediate device (44) receives the unicast packet, tags (48) VLAN ID internally on the unicast packet and forwards the unicast packet to the uplink port connected by the L2 switch (42), and then the L2 switch (42) will receive the tagged (48) unicast packet.

Step 3:

The L2 switch (42) receives the unicast packet tagged (48) with the VLAN ID and notices that the VLAN ID is different from the PVID of port 1. Since we have disabled ingress filtering of all the L2 switch (42) ports, the L2 switch (42) will pass the packet even the VLAN ID is different.

The L2 switch (42) will dynamically learn the MAC address of source station A (46) from port 1 belongs to the VLAN ID of the unicast packet.

The L2 switch (42) will find that only port 3 (the IDP service port) belongs to the same VLAN ID of the unicast packet because the IDP service port belongs to all VLAN, and then the L2 switch (42) forwards the packet to port 3.

Note that the L2 switch (42) will not forward the unicast packet directly to port 2 even if the MAC address of destination station B (47) has been learnt from port 2 in the VLAN ID, because port 2 is forbidden to become a member of any VLAN dynamically except the PVID of itself.

Step 4:

The IDP service provider (41) receives the unicast packet and drops this unicast packet if it is not secure.

Then the IDP service provider (41) lookups the source MAC address of the unicast packet to the source MAC address lookup table (as shown in FIG. 5) and find that the packet from port 1 tagged (48) with the VLAN ID shall be tagged (48) the PVID of port 2 even the packet has been tagged (48).

Step 5

The IDP service provider (41) tags (48) the PVID of port 2 on the tagged (48) unicast packet, and then the IDP service provider (41) sends the double tagged (49) packet to the L2 switch (42).

Step 6:

The L2 switch (42) receives the unicast packet. Although this packet has been double tagged (49), the L2 switch (42) will only consider the first tag (48) of the packet which is just tagged (48) by the IDP service provider (41) and consider this unicast packet belongs to the PVID of port 2; the L2 switch (42) will learn the MAC address of source station A (46) from port 3 belongs to the PVID of port 2, and the L2 switch (42) will find that only port 2 belongs to the same VLAN of the packet.

The L2 switch (42) forwards the double tagged (49) unicast packet to port 2, and strips the first tag (48) of the unicast packets because the egress rule of port 2 is untagged. The unicast packet is now return to tagged (48) packet the L2 switch (42) has received in step 3.

The L2 switch (42) sends this tagged (48) packet to the intermediate device (44) connected to port 2.

Step 7:

The intermediate device (44) receives the tagged (48) packet and forwards the packet to the port which destination station B (47) is connected and strips the tag (48) of unicast packet.

The destination station B (47) will receive this untagged unicast packet which is send by source station A (46) originally.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

### BRIEF DESCRIPTION OF THE DRAWING

The invention will be better understood and objects other than those set forth above will become apparent when consideration is given to the following detailed description thereof. Such description makes reference to the annexed drawings wherein:

FIG. 1 is the IDP service provider schematic diagram according to the present invention;

FIG. 2 is a static multiple IDP in access link schematic diagram according to the present invention;

FIG. 3 is the source MAC address lookup table in access link schematic diagram according to the present invention;

FIG. 4 is a static multiple IDP in trunk link schematic diagram according to the present invention;

FIG. 5 is the source MAC address lookup table in trunk link schematic diagram according to the present invention.

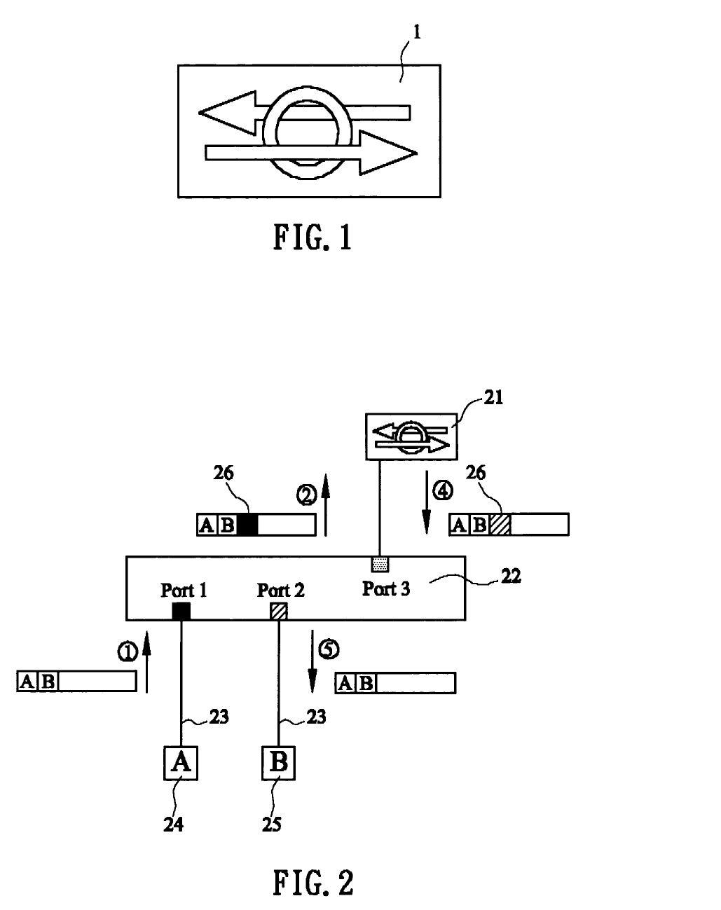

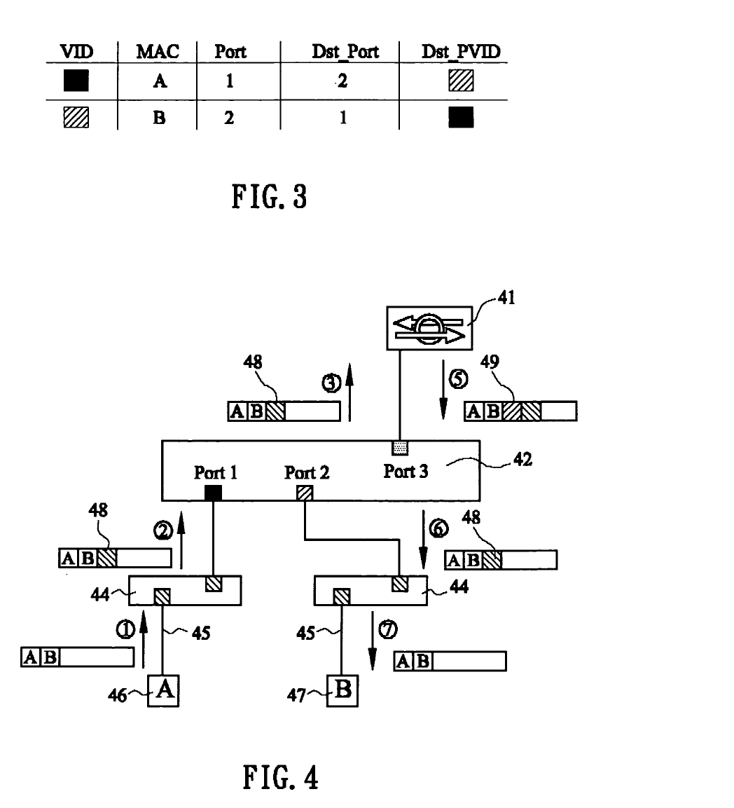

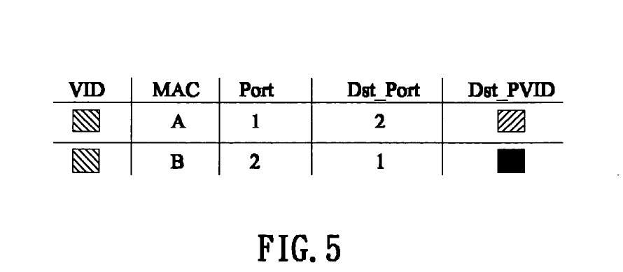

### DRAWING NUMBER DESCRIPTION

21: IDP service provider
22: L2 switch
23: access link
24: source station A
25: destination station B
26: tag
41: IDP service provider
42: L2 switch
43: trunk link
44: intermediate device
45: access link
46: source station A
47: destination station B
48: tag
49: double tag

What is claimed is:

1. A checking method for applying in the field of network packet contents of network security switch, comprising steps of:
a) among several network stations in network terminations, by means of a media access control(MAC) of the address of source/destination of a unicast packet to decide between any two source/destination address among said several network stations;
b) from a source address station, by means of a access link to link said source address station to a port of a switch, and a destination station also link to another port of said switch by said access link;
c) linking a specific port of said switch to a service provider; and or
d) setting a intermediate device between said source/destination stations and said switch, and linking said source/destination stations to said intermediate device by a access link, and linking said switch to said intermediate device by a trunk link.

2. A checking method for applying in the field of network packet contents of network security switch according to claim 1 wherein said switch is a L2 switch (layer 2 switch), a L3 switch or a L4 switch etc.

3. A checking method for applying in the field of network packet contents of network security switch according to claim 2 wherein said L2 switch is a exchange node in network security mechanism, it not only can set a individual different VLAN to avoid interference between different work areas and different members, but it also can get the efficiency of filtration by specific link port linking by specific person through MAC address limitation.

4. A checking method for applying in the field of network packet contents of network security switch according to claim 1 wherein said IDP service provider is a Intrusion Detection/Prevention system service provider, it can be configured in two modes, static mode and dynamic mode, in static mode, each of the L2 switch ports is defined static in pairs, the network traffic received from one port will be statically transmitted to another after checked by said IDP service provider, it means where the packets coming will decide where the packets going, and then, in the dynamic mode, all the packets will be switched as usual but checked and considered by said IDP service provider, wherein said IDP service provider fetches the filtering database from said L2 switch and uses this information to judge where the packets must go, said L2 switch will not do the real switching, it only learns the forwarding information instinctively and passes the information when said IDP service provider querying.

5. A checking method for applying in the field of network packet contents of network security switch according to claim 1 wherein said IDP service provider is a specific designed can cooperate with any said L2 switch that matched some popular specifications and provide security service on the network traffic through said L2 switch, it do not need to replace said L2 switch, it just plug said specific designed IDP to said L2 switch they have already had, and play what they original want with security service.

6. A checking method for applying in the field of network packet contents of network security switch according to claim 1 wherein said service provider i.e. a IDP service provider, said IDP service provider can handle both IDS (intrusion detection system) and IPS (intrusion prevention system) two systems do at the same time according to the user configuration and the network environment.

7. A checking method for applying in the field of network packet contents of network security switch according to claim 3 wherein said VLAN we can definite VLAN-aware and VLAN-unaware, and VLAN-aware means devices are devices that are able to understand VLAN membership and VLAN frame formats.

8. A checking method for applying in the field of network packet contents of network security switch according to claim 3 wherein said VLAN we can definite VLAN-aware and VLAN-unaware, and VLAN-unaware means devices are devices that are not able to understand VLAN membership and VLAN frame formats.

9. A checking method for applying in the field of network packet contents of network security switch according to claim 1 wherein said trunk link is a LAN segment used for multiplexing VLANs between VLAN bridges, all the devices that connect to said trunk link must be VLAN-aware.

10. A checking method for applying in the field of network packet contents of network security switch according to claim 1 wherein said access link is a LAN segment used to multiplex one or more VLAN-unaware devices into a port of a VLAN bridge.

11. A checking method for applying in the field of network packet contents of network security switch according to claim 1 wherein said intermediate devices are devices that are linking to L2 switch by trunk link, and are linking to source/destination stations by access link, wherein said source/destination stations are all VLAN-unaware and all are untagged packets, said intermediate device send the packets to L2 switch after tagged, then send said tagged packets to IDP service provider through a specific linking port, and send it back to L2 switch after check by IDP service provider.
